(19) United States
(12) Patent Application Publication
(10) Pub. No.: US 2024/0140770 A1
(43) Pub. Date: May 2, 2024

(54) ENHANCED WHEELCHAIR MAINTENANCE LIFTING PLATFORM

(71) Applicants: Amy Nichelle Simmons, Mesquite, TX (US); Andrew Damon Burton, Mesquite, TX (US)

(72) Inventors: Amy Nichelle Simmons, Mesquite, TX (US); Andrew Damon Burton, Mesquite, TX (US)

(21) Appl. No.: 18/498,945

(22) Filed: Oct. 31, 2023

Related U.S. Application Data
(60) Provisional application No. 63/381,746, filed on Oct. 31, 2022.

(51) Int. Cl. B66F 15/00

(52) U.S. Cl. CPC B66F 15/00

(57) ABSTRACT

This disclosure describes wheelchair maintenance lifting platforms including a base, a riser portion attached to the base, a riser insert slidable within the riser portion, a cradle attached to the riser insert and configured to lift a portion of a wheelchair, and a handle extending from the riser portion.

### CROSS-REFERENCE TO RELATED APPLICATION(S)

This application is related to an claims priority under 35 U.S.C. § 119(e) from U.S. Provisional Patent Application No. 63/381,746, filed Oct. 31, 2022, titled “WHEELCHAIR MAINTENANCE LIFTING PLATFORM,” the entire content of which is incorporated herein by reference for all purposes.

### TECHNICAL FIELD

Embodiments of the present invention generally relate to a wheelchair lifting platform.

### BACKGROUND

There is currently no quick, easy and portable way by which a wheelchair user or a caregiver can lift the rear wheels of a wheelchair off of the ground while the wheelchair user is still sitting in the wheelchair to perform maintenance or cleaning of the wheels, tires, spokes, bearings and axles without permanently affixing heavy and cumbersome parts to the wheelchair. Adding additional parts to the wheelchair would add weight to the wheelchair and complicate the use of the wheelchair either independently or with a caregiver.

### BRIEF DESCRIPTION OF THE DRAWINGS

FIG. 1 illustrates an example perspective view of a wheelchair maintenance lifting platform in accordance with one embodiment.

FIG. 2 illustrates an example side view of the wheelchair maintenance lifting platform of FIG. 1 in accordance with one embodiment.

FIG. 3 illustrates an example side view of the wheelchair maintenance lifting platform of FIG. 1 engaging a wheelchair in accordance with one embodiment.

FIG. 4 illustrates an example side view of the wheelchair maintenance lifting platform of FIG. 1 engaging the wheelchair of FIG. 3 in accordance with one embodiment.

FIG. 5 illustrates an example side view of the wheelchair maintenance lifting platform of FIG. 1 engaging the wheelchair of FIG. 3 in accordance with one embodiment.

FIG. 6 illustrates an example side view of the wheelchair maintenance lifting platform of FIG. 1 engaging the wheelchair of FIG. 3 in accordance with one embodiment.

### DETAILED DESCRIPTION

Aspects of the present disclosure involve an enhanced wheelchair maintenance lifting platform.

In one or more embodiments, a wheelchair lifting platform may allow a wheelchair user or caregiver to safely lift and hold the rear wheels of a wheelchair off of the ground while the wheelchair user is sitting in the wheelchair. The rear wheels and the wheelchair user may be lifted with the action of a lever, and cradled securely on the platform, allowing the user or caregiver to perform maintenance or cleaning of the wheels, tires, spokes, bearings, and/or axles of the wheelchair without the user needing to exit the wheelchair. The lifting platform accomplishes this without permanently affixing heavy and cumbersome parts to the wheelchair that would add weight to the wheelchair and complicate the use of the wheelchair either independently or with a caregiver.

In one or more embodiments, the wheelchair lifting platform may include a cradle for supporting a camber tube of the wheelchair and facilitating the lifting of the wheelchair. The wheelchair lifting platform may include a riser into which a riser insert may slidably insert. The riser insert may slide outwardly from the riser to lift the cradle, which may be affixed or otherwise operatively connected to the riser insert. Lifting or raising the cradle may lift or lower the wheelchair correspondingly because the camber tube of the wheelchair may sit on the cradle. To lift of lower the riser insert, a handle with a handle insert may function as a lever. For example, pushing or pulling the handle in one direction may cause the base to sit on the ground (e.g., forming a 90 degree angle with the ground), lifting the wheelchair. Pushing or pulling the handle in the other direction may cause the base to rotate so that it forms a less than 90 degree angle with the ground, lowering the cradle.

In one or more embodiments, the wheelchair lifting platform may include a baseplate that serves as the base for the platform when the wheelchair is in the lifted position, which may have a bend (e.g., 45 degrees or another angle) on one end, and that may act as a fulcrum during the lifting process. The wheelchair lifting platform may include the riser as a vertical structure of the platform, and which may house the riser insert. Together, the riser and riser insert may provide height adjustability so the lifting platform can be used with as many wheelchair tire and wheel configurations as possible. The wheelchair lifting platform may include gussets that may affix to the baseplate and the riser to add strength and stability to the entire system. The gussets also may provide a method of stabilizing the removable handle. The wheelchair lifting platform may include the riser insert that is housed by the riser to provide height adjustment and hold the cradle, which aids in the lifting of the wheelchair and provides a secure resting place for the camber tube when in the lifted position. The wheelchair lifting platform may include a handle that may be removable for portability and connects to the riser and the gussets. The handle acts as the lever in the lifting process. The wheelchair lifting platform may include a handle insert, which allows the handle length to be adjusted for better leverage or to help the independent wheelchair user to reach the handle better. The handle insert also may be removable for portability.

In one or more embodiments, for operation, first, the wheelchair user may remove their feet from the footrest. Next, the wheelchair user may position the lifting platform in front of the footrest with the handle facing forward. The wheelchair user may then tilt the lifting platform backward by pulling the handle toward themselves until it rests on the lip of the baseplate. Once tilted, the user may lift the lifting platform above the footrest and begin to maneuver it under the wheelchair between the down tubes of the wheelchair frame. After the lifting platform is under the chair, the user may sit the lip of the baseplate on the ground under the wheelchair and slide it backward until the camber tube is nested in the cradle. Finally, the user may push the handle forward until the wheelchair is lifted and has come to rest on the platform. After the maintenance is complete and the wheels have been securely replaced on the wheelchair, the user may pull the handle until the rear wheels are once again on the ground. The use of the wheelchair maintenance lifting platform by a caregiver is very similar. There is no need to remove the wheelchair user's feet from the footrest because the caregiver may be performing all of the same steps as the independent user. The only difference is the caregiver may be performing the same steps from the back of the wheelchair, and the handle may be facing backward, not forward.

In one or more embodiments, the amount of the riser insert that may extend from the riser may be adjustable for different heights. The longer the riser insert extends out from the riser, the higher the cradle. The riser insert and the riser may include holes (e.g., openings, etc.) through which a pin may extend such that when holes of the riser insert align with holes of the riser, the pin may lock the riser insert in place within the riser at a desired length. When the cradle is positioned under the camber tube of the wheelchair and the handle is pushed downward (e.g., toward the ground) to position the base at a 90 degree angle with the ground, the cradle will push upward from underneath the camber tube to lift the camber tube, wheel, and wheelchair.

The above descriptions are for purposes of illustration and are not meant to be limiting. Numerous other examples, configurations, processes, etc., may exist, some of which are described in greater detail below. Example embodiments will now be described with reference to the accompanying figures.

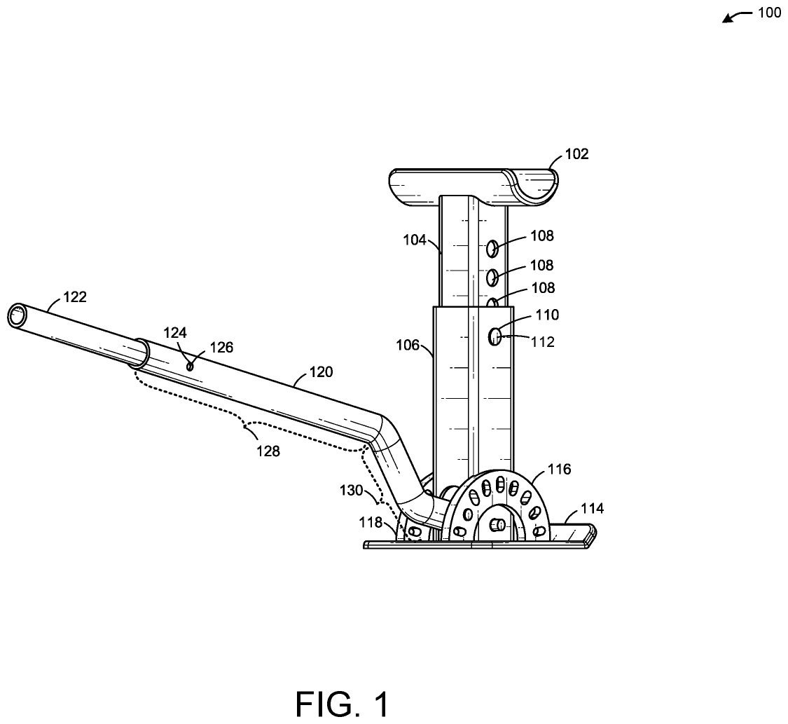

FIG. 1 illustrates an example perspective view of a wheelchair maintenance lifting platform 100 in accordance with one embodiment.

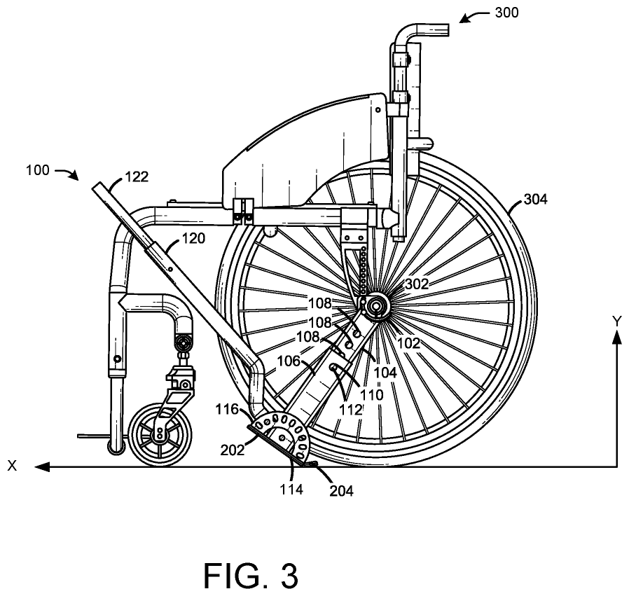

Referring to FIG. 1, the wheelchair maintenance lifting platform 100 may include a cradle 102, which may be curved in shape to support a camber tube or other round portion of a wheelchair (e.g., as shown in FIGS. 3-6), and which may be attached to a riser insert 104 that may slide into and out of a riser 106 to adjust a height of the wheelchair maintenance lifting platform 100 and, correspondingly, a height of a wheelchair whose weight is partially supported by the cradle 102. The riser insert 104 may include holes 108 and the riser 106 may include a hole 110 through which a pin 112 may extend so that when any of the holes 108 and the hole 110 axially align, the pin 112 may extend through each of them to secure the riser insert 104 in place. Because the riser insert 104 may include multiple holes 108, the length of the riser insert 104 extending from the riser 106 may be adjustable, allowing for different heights of the wheelchair maintenance lifting platform 100.

Still referring to FIG. 1, the riser 106 may be attached to a base 114. A gusset 116 and a gusset 118 also may be attached to the base 114 on opposite respective sides of the riser 106 to support the riser 106. Attached to the riser 106 may be a handle 120, and optionally extending from the handle 120 may be a handle insert 122, whose length (e.g., amount of extension from the handle 120) may be adjustable. The handle 120 and the handle insert 122 may include one or more holes 124 through which a pin 126 may extend to align the holes axially and set the length of the handle insert 122 (e.g., which may extend into and out of the handle 120). The handle 120 may include a straight portion 128 and a curved portion 130, and the curved portion 130 may operatively attach to the riser 106.

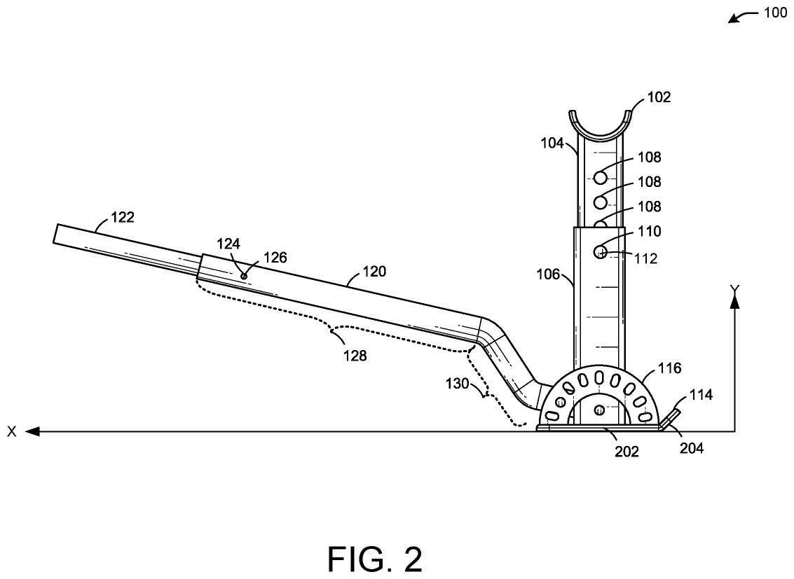

FIG. 2 illustrates an example side view of the wheelchair maintenance lifting platform 100 of FIG. 1 in accordance with one embodiment.

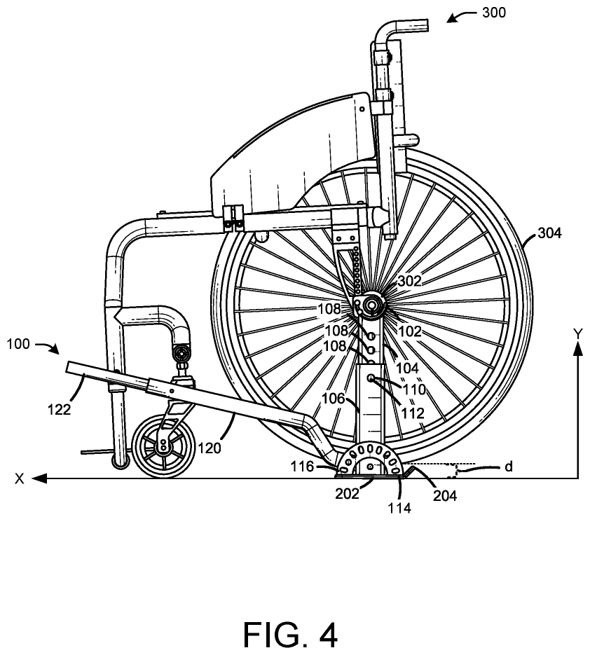

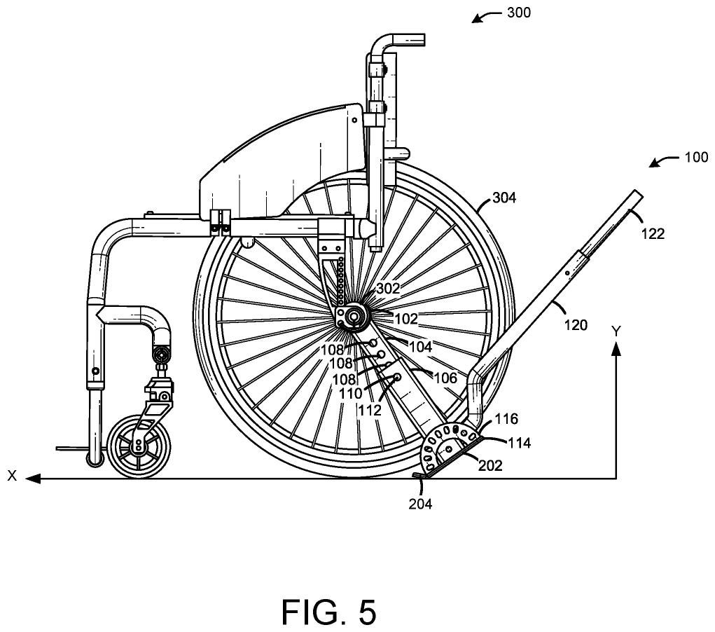

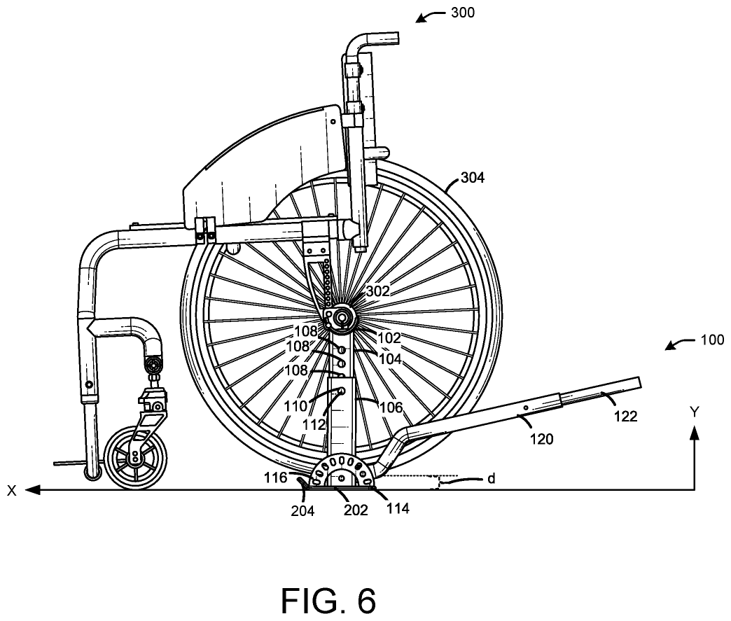

Referring to FIG. 2, it is shown that when a portion 202 of the base 114 is parallel to the ground (e.g., represented by the x-axis), the riser insert 104 may be perpendicular to the ground (e.g., parallel with the y-axis). At this orientation, the cradle 102 may be at its highest point for lifting and supporting a wheelchair (e.g., as shown in FIGS. 4 and 6). Also, the base 114 is shown as curved so that when the portion 202 of the base 114 is parallel to (e.g., on) the ground, a portion 204 of the base 114 is not on the ground. The portion 204 is angled with respect to the ground and the portion 202 so that the portion 204 may slide on the ground to position the cradle 102 underneath a portion of a wheelchair (e.g., as shown in FIGS. 3 and 5) without lifting the wheelchair until force applied to the handle 120 causes the base 114 to rotate until the portion 202 is on the ground, lifting the cradle 102 and anything supported by the cradle 102.

FIG. 3 illustrates an example side view of the wheelchair maintenance lifting platform 100 of FIG. 1 engaging a wheelchair 300 in accordance with one embodiment.

Referring to FIG. 3, the cradle 102 may be positioned at least partially underneath (e.g., respective to the y-axis) a portion (e.g., a camber tube 302 supporting a wheel 304) whose weight may be supported by the cradle 102. For example, because the camber tube 302 may be circular or otherwise curved in shape, the cradle 102 also may be curved in shape. As shown in FIG. 3, the portion 204 may be touching the ground (e.g., the x-axis) while the portion 202 may be off the ground to allow for positioning the cradle 102 underneath the camber tube 302 while the wheel 304 of the wheelchair 300 is on the ground. In this position, the riser 106 and the riser insert 104 may be at an angle less than 90 degrees (e.g., not perpendicular with) from the ground, so the cradle 102 may engage the camber tube 302 while the wheel 304 is on the ground (e.g., without lifting the wheel 304 and the wheelchair 300).

FIG. 4 illustrates an example side view of the wheelchair maintenance lifting platform 100 of FIG. 1 engaging the wheelchair 300 of FIG. 3 in accordance with one embodiment.

Referring to FIG. 4, the handle 120 is pushed or pulled downward toward the ground (e.g., the x-axis) with respect to the position of the handle 120 in FIG. 3. Pushing or pulling the handle 120 toward the ground may cause the portion 202 of the base 114 to touch the ground, rotating the riser insert 104 and the riser 106 to a perpendicular angle with respect to the ground, thereby raising the cradle 102 with respect to its position in FIG. 3, thereby lifting the camber tube 302, the wheel 304, and the wheelchair 300 a distance d from the ground.

FIG. 5 illustrates an example side view of the wheelchair maintenance lifting platform 100 of FIG. 1 engaging the wheelchair 300 of FIG. 3 in accordance with one embodiment.

FIG. 6 illustrates an example side view of the wheelchair maintenance lifting platform 100 of FIG. 1 engaging the wheelchair 300 of FIG. 3 in accordance with one embodiment.

Referring to FIG. 5 and FIG. 6, the wheelchair maintenance lifting platform 100 may be oriented so that the handle 120 extends from the base 114 toward the rear of the wheelchair 300, which may be desirable when a caregiver is using the wheelchair maintenance lifting platform 100 (e.g., in contrast with FIG. 3 and FIG. 4 which may be more desirable for a wheelchair user when sitting in the wheelchair 300). The same principles of FIG. 3 and FIG. 4 apply. Specifically, FIG. 5 shows how to engage the wheelchair 300 with the wheelchair maintenance lifting platform 100 without lifting the wheel 304, and FIG. 6 shows the wheelchair maintenance lifting platform 100 lifting the camber tube 302, the wheel 304, and the wheelchair 300 (e.g., a distance d) from the ground (e.g., the x-axis) when the handle 120 is pushed or pulled toward the ground.

It is understood that the above descriptions are for purposes of illustration and are not meant to be limiting.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A wheelchair lifting platform comprising:
a base;
a riser portion attached to the base;
a riser insert slidable within the riser portion;
a cradle attached to the riser insert and configured to lift a portion of a wheelchair; and
a handle extending from the riser portion.

2. The wheelchair lifting platform of claim 1, wherein the cradle is curved in shape.

3. The wheelchair lifting platform of claim 1, wherein a height of the riser insert is adjustable by sliding the riser insert outward from the riser portion.

4. The wheelchair lifting platform of claim 1, wherein the base comprises a first portion perpendicular to the riser portion and a second portion along a different lateral axis than the first portion.

5. The wheelchair lifting platform of claim 4, wherein the cradle is configured to engage a camber tube of the wheelchair when the first portion of the base is on the ground and when the second portion of the base is on the ground.

6. The wheelchair lifting platform of claim 4, wherein pushing or pulling the handle causes the base to move from a first position with the second portion on the ground while the cradle engages a camber tube of the wheelchair to a second position with the first portion on the ground while the cradle engages the camber tube of the wheelchair.

7. The wheelchair lifting platform of claim 1, further comprising a handle insert slidable within the handle to adjust a length of the handle insert extending from the handle.

8. A wheelchair lifting platform comprising:
a riser portion;
a riser insert slidable within the riser portion;
a cradle attached to the riser insert and configured to lift a portion of a wheelchair; and
a handle extending from the riser portion.

9. The wheelchair lifting platform of claim 8, further comprising:
a base attached to the riser portion.

10. The wheelchair lifting platform of claim 9, further comprising at least one gusset attached to the base and configured to stabilize the riser portion.

11. The wheelchair lifting platform of claim 9, wherein the base comprises a first portion perpendicular to the riser portion and a second portion along a different lateral axis than the first portion.

12. The wheelchair lifting platform of claim 11, wherein the cradle is configured to engage a camber tube of the wheelchair when the first portion of the base is on the ground and when the second portion of the base is on the ground.

13. The wheelchair lifting platform of claim 11, wherein pushing or pulling the handle causes the base to move from a first position with the second portion on the ground while the cradle engages a camber tube of the wheelchair to a second position with the first portion on the ground while the cradle engages the camber tube of the wheelchair.

14. The wheelchair lifting platform of claim 8, wherein the cradle is curved in shape.

15. The wheelchair lifting platform of claim 8, wherein a height of the riser insert is adjustable by sliding the riser insert outward from the riser portion.

16. The wheelchair lifting platform of claim 8, further comprising a handle insert slidable within the handle.

17. The wheelchair lifting platform of claim 16, wherein a length of the handle insert extending from the handle is slidably adjustable.

18. A wheelchair lifting platform comprising:
an riser insert slidably adjustable within a riser portion;
a cradle attached to the riser insert and configured to lift a portion of a wheelchair; and
a handle extending from the riser portion.

19. The wheelchair lifting platform of claim 18, further comprising:
a base attached to the riser portion; and
at least one gusset attached to the base and configured to stabilize the riser portion.

20. The wheelchair lifting platform of claim 19, wherein the base comprises a first portion perpendicular to the riser portion and a second portion along a different lateral axis than the first portion.
